(19) United States
(12) Patent Application Publication
(10) Pub. No.: US 2010/0246479 A1
(43) Pub. Date: Sep. 30, 2010

(54) METHOD AND SYSTEM FOR ESTABLISHING AND MAINTAINING A HIGH SPEED RADIO ACCESS BEARER FOR FOREGROUND APPLICATION

(75) Inventors: Joseph Deu-Ngoc, Waterloo (CA); Jeffrey William Wirtanen, Kanata (CA); Fraser Gibbs, Waterloo (CA)

Correspondence Address: MOFFAT-RIM, 427 Laurier Avenue W., Suite 1200, Ottawa, ON, K1R 7Y2, CA

(73) Assignee: RESEARCH IN MOTION LIMITED, Waterloo (CA)

(21) Appl. No.: 12/413,418

(22) Filed: Mar. 27, 2009

(51) Int. Cl. H04W 40/00; H04L 12/56

(52) U.S. Cl. 370/328; 370/401

(57) ABSTRACT

A method and system for establishing and maintaining a high speed tunnel between a mobile device and a network, the method determining whether a foreground application on the mobile device requires the high speed tunnel, and if the foreground application requires the high speed tunnel, closing all tunnels from the mobile device to a network except the tunnel for the foreground application.

### FIELD OF THE DISCLOSURE

The present disclosure relates to radio bearers for mobile devices and in particular, to high-speed radio access bearers.

### BACKGROUND

A mobile device requires the establishment of a radio access bearer in order to communicate with the wireless network infrastructure. Furthermore, some devices allow the establishment of a multiple radio access bearers for communication. In one instance, multiple radio access bearers can be dependent on the device requiring multiple packet data protocol (PDP) contexts. Thus, for example, a device may have a proprietary PDP context for the manufacturer of the device, a general wireless application protocol (WAP) context for browsing, a multi-media messaging service (MMS) PDP context for MMS applications, a streaming media PDP context for streaming media applications, among others. As will be appreciated, a PDP context is a term that is generally referred to in the third generation partnership project (3GPP) and more generally the term “tunnel” is used herein to refer to a data connection to a particular network.

The opening of multiple tunnels to a network can have disadvantages. For example, in the third generation partnership project high-speed downlink access (HSPDA), tunnels can be opened which have higher data transfer speeds and capacities. Current HSPDA deployments support downlink speeds of, for example, 1.8, 3.6, 7.2 or 14.4 Mbps.

While HSPDA networks and other high-speed networks may allow the establishment of multiple tunnels, in some instances only the first tunnel established is granted a high-speed radio access bearer. Any subsequent tunnel activation causes a downgrade of the radio access bearers to low-speed radio access bearers. This means that the high-speed radio access bearer is dropped for multiple low-speed radio access bearers. The dropping of a high-speed radio access bearer could result in degraded user experience.

### BRIEF DESCRIPTION OF THE DRAWINGS

The present disclosure will be better understood with reference to the drawings in which:

FIG. 1 is a block diagram showing a process for prioritizing tunnels based on foreground applications;

FIG. 2A is a block diagram illustrating a tunnel prioritization process for controlling active tunnels;

FIG. 2B is a block diagram providing a continuation of the process of FIG. 2A;

FIG. 3 is a block diagram of an alternative embodiment the tunnel prioritization process of FIG. 2A having a mobile device protection mode;

FIG. 4 is a block diagram of an alternative embodiment the tunnel prioritization process of FIG. 3 having a phone experience mode; and

FIG. 5 is a block diagram of an exemplary mobile device capable of being used with the methods of the present disclosure.

### DETAILED DESCRIPTION

As used herein, the following definitions apply:
a. Foreground application—refers to the application currently displayed on a display;
b. Background application—refers to any application that is not a foreground application;
c. Tunnel—refers to a data connection for one or more applications on a particular network; for 3GPP, this is a PDP context.
d. Opened Tunnel—refers to a tunnel that is active;
e. Closed Tunnel—refers to a tunnel that is not active;
f. Watermark—the number of tunnels that can be simultaneously be opened on a device. Also referred to as maximum tunnel count;
g. Focused tunnel—this is the highest priority tunnel and by default the tunnel that is opened first. For improved user experience, in one embodiment the focused tunnel is the tunnel used by the foreground application. An exception occurs when in a device protection mode;
h. A Device Tunnel—is a tunnel used for obtaining proprietary device services, such as, but not limited to, a proprietary push email service. In one embodiment it is the highest priority tunnel when there is no other focused tunnel and is the second highest priority tunnel when there is a focused tunnel. Therefore, if the watermark is greater then one, there will be one tunnel reserved for device services. The device tunnel, in one embodiment, is never the focused tunnel. Instead the focus is simply lost, meaning there is no focused tunnel, allowing the device to regain the device services. The device tunnel, when there is no focused tunnel, may become a high speed tunnel;
i. A Device Protection Mode—is a mode of operation that ensures a device tunnel is always available;
j. Application Solo Mode—is a mode of operation that attempts to ensure that an application requesting a tunnel obtains a high-speed tunnel. The application solo mode is associated with an application, and is therefore in turn associated with a tunnel.

The present disclosure provides a method for establishing and maintaining a high speed tunnel between a mobile device and a network, the method comprising: determining whether a foreground application on the mobile device requires the high speed tunnel, and if the foreground application requires the high speed tunnel, closing all tunnels from the mobile device to a network except the tunnel for the foreground application.

The present disclosure further provides a mobile device configured to establish and maintain a high speed tunnel is open to a network, the mobile device comprising: a communications subsystem; and a processor, the processor configured to determine whether a foreground application on the mobile device requires the high speed tunnel, and if the foreground application requires the high speed tunnel, close all tunnels using the communications subsystem from the mobile device to a network except the tunnel for the high speed radio access bearer.

In high-speed networks, the first radio access bearer guarantees that the first data connection is granted as a high-speed data connection. However, some networks implement further data connections to a mobile device in a way that causes the network to downgrade all active data connections for the device to a slower speed.

Aside from watermarking, which is a way to determine how many simultaneous data connections are allowed on a particular network, it would be useful for a mobile to know whether a particular data connection is high-speed. Unfortunately, there is no way for the mobile to know whether a network allows simultaneous high-speed data connections and only that the network is capable of high-speed data connections.

The present disclosure therefore provides for a way to ensure that an application in the foreground, which requires a high-speed tunnel, obtains the high speed tunnel by causing other tunnels to be deactivated to ensure the high-speed data tunnel is granted.

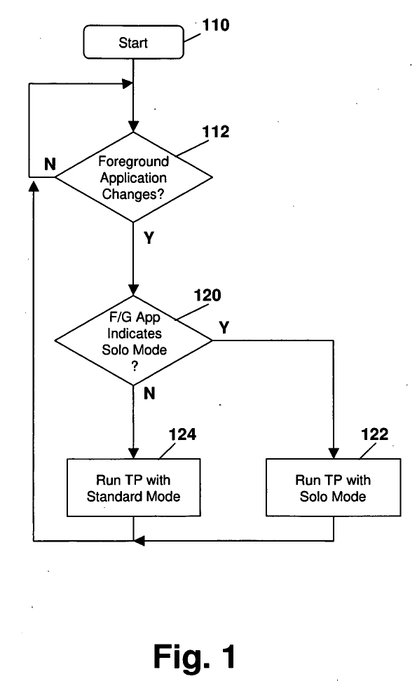

Reference is now made to FIG. 1, which illustrates a block diagram of a process for starting a tunnel prioritization process when focus changes on a user interface of the mobile device. FIG. 1 starts at block 110 and proceeds to block 112 in which a check is made to see if the foreground application changes. As will be appreciated by those in the art, the foreground application can change in various situations. For example, if a user first starts a device, the foreground application for the newly started device has changed. Other situations include starting a new application which then becomes the foreground application, minimizing a foreground application, quitting a foreground application, or changing the foreground application through a menu selection, among others.

If the foreground application has not changed, as determined in block 112, the process continues to loop until the foreground application changes.

When the foreground application changes, as determined in block 112, the process proceeds to block 120 in which a check is made to determine whether the foreground application has a flag to indicate an application solo mode. As indicated above, an application solo mode is a mode of operation that attempts to ensure that the requesting application obtains a high-speed tunnel. The application solo mode is controlled, in one embodiment, by a flag set by the application using the tunnel. The ultimate decision on which applications should be allowed have a flag for the application solo mode is, in one embodiment, the responsibility of the application executive. For example, this could be the operating system or virtual machine that is running the application.

In the present disclosure, when a tunnel is associated with an application requiring an application solo mode, the tunnel is marked as an application solo mode tunnel. In one embodiment it is required that the tunnel is also a focused tunnel for the application solo mode behavior to take effect. Here, the rationale is that if an application has a requirement for an application solo mode tunnel, then the application is displayed in the foreground. If the user is not using that application and the application is in the background then the requirement for high-speed is less and other tunnels may be opened to provide the services required on the mobile device.

The check in block 120 determines whether or not the foreground application has a flag to indicate an application solo mode. If yes, the process proceeds to block 122 in which a tunnel priority process is run indicating that an application solo mode should be active. Conversely, if the application does not indicate application solo mode, the process proceeds to block 124 in which a tunnel prioritization process is run with a standard mode of operation.

From blocks 122 and 124, the process proceeds back to block 112 to check whether or not the foreground application has changed.

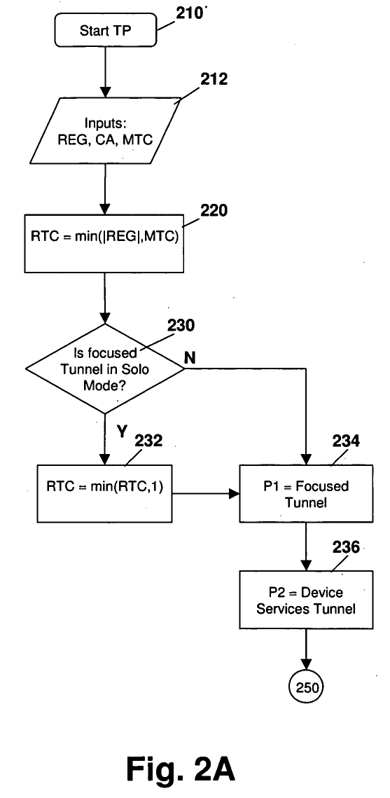

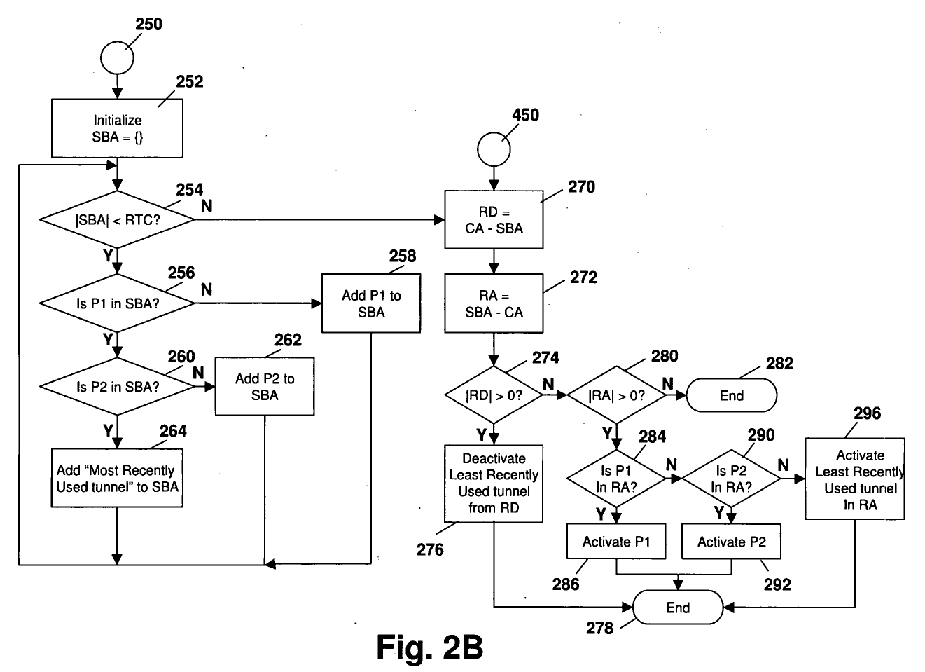

The tunnel prioritization process, and variants thereof, are described herein with reference to FIGS. 2A, 2B, 3 and 4. The process can be started in by occurrence of various events, including the change in foreground application, as described with reference to FIG. 1, but also whenever a tunnel is activated or deactivated, a tunnel is requested, and the watermark changes. In each case the process starts at block 210.

Reference is now made to FIG. 2A. FIG. 2A shows that the tunnel prioritization process that is started at block 210 and has inputs as shown in block 212. In particular, the inputs required for the process of FIG. 2A include a set of currently registered tunnels (REG), which is an indication of all the possible tunnels that are registered and could be activated. Examples include a device tunnel (t_{dev}), a WAP tunnel (t_{WAP}), an MMS tunnel (t_{MMS}) and a streaming media tunnel (t_{steaming}), among others. Thus, if the device has four tunnels registered, the input REG consists of a set comprising four tunnels.

A second input provided to the process of FIG. 2A is a set of currently active tunnels (CA). The input CA provides a set of tunnels that have been opened for the mobile device.

A third input is the watermark or maximum tunnel count (MTC), which provides an indication as to how many tunnels can be opened on the particular network that the mobile device is registered with.

The process proceeds to block 220 in which the required tunnel count (RTC) is set. As will be appreciated by those in the art, the number of tunnels that should be opened should be no greater then the number of tunnels registered or the watermark amount. In other words, the required tunnel count is the minimum of the number of registered tunnels and the watermark count. As used in block 220, and in the remainder of the figures, the operator pair “|” as used in |REG| defines the size of the set “REG” or the number of elements in the set “REG”.

From block 220, the process then proceeds to block 230, in which a check is made to determine whether the focused tunnel is in application solo mode. As used herein, the focused tunnel is the tunnel for the foreground application and the application solo mode is determined in block 120 of FIG. 1.

If the focused tunnel is in application solo mode, the process proceeds to block 232 in which the required tunnel count is set to have the maximum number of one, thus ensuring that only one tunnel can be opened.

If the focused tunnel is not in application solo mode, or after block 232, the process proceeds to block 234. In block 234, the highest priority tunnel denoted as P1 in FIG. 2 is set to be the focused tunnel.

From block 234 the process proceeds to block 236 in which the second highest priority tunnel is set. In one embodiment, the second highest priority tunnel denoted as P2 can be set to include the device tunnel. However, in other embodiments different tunnels can be set to the second highest priority.

The process then proceeds to entry point 250 of FIG. 2B. Reference is now made to FIG. 2B.

From entry point 250, the process proceeds to block 252 where, in the first pass through the tunnel prioritization process, the “should be active” set of tunnels (SBA) is set to be an empty set. As used in block 252, SBA is a set and the operator “{ }” indicates an empty set.

The process then proceeds to block 254 in which the number of tunnels that should be active is checked against the required tunnel count. If the number of tunnels that should be active is less then the required tunnel count the process proceeds to block 256 in which a check is determine whether the highest priority tunnel is within the group of tunnels that should be active. If no, the process proceeds to block 258 in which the highest priority tunnel is added to the group of tunnels that should be active and the process proceeds back to block 254.

If the check in block 256 determines that the highest priority tunnel is within the group of tunnels that should be active, the process proceeds to block 260 in which a check is made to determine whether the second highest priority tunnel is within the group of tunnels that should be active. If no, the process proceeds to block 262 and adds the second highest priority tunnel to the group of tunnels that should be active and the process proceeds back to block 254. Conversely, from block 260 if the second highest priority tunnel is within the group of tunnels that should be active, the process proceeds to block 264 in which the most recently used tunnel is added to the set of tunnels that should be active and the process proceeds back to block 254.

From block 254, if the number of tunnels within the set of tunnels that should be active is not less then the required tunnel count, the process then proceeds to block 270, in block 270 a determination is made to determine the set of tunnels which require deactivation (RD). In particular, the tunnels that require deactivation are the currently active tunnels that are not part of the SBA set. As used in block 270 and 272, the “-” operator indicates the elements in the set preceding the operator but not in the set following the operator. Thus, in block 270, the expression “CA-SBA” indicates the elements in the set CA but not in the set SBA.

The process then proceeds to block 272 in which the set of tunnels that require activation (RA) are determined. In particular, the tunnels that require activation are those within the SBA set that are not currently active.

The process then proceeds to block 274 in which it is determined whether or not the set of tunnels requiring deactivation is greater then zero. If yes, then process proceeds to block 276 and deactivates the least recently used tunnel from the recently used tunnels that require deactivation and the process then proceeds to block 278 and ends. As will be appreciated, the deactivation of the tunnel causes the tunnel prioritization process to be restarted, in effect ensuring that all tunnels requiring activation and deactivation are processed. In an alternative embodiment the process could loop from block 276 back to block 274.

If the check in block 274 determines that there are no tunnels to be deactivated, the process proceeds to block 280 in which a determination is made to identify whether there are any tunnels that require activation. If not, the process proceeds to block 282 and ends.

Conversely, if it is determined in block 280 that tunnels require activation the process proceeds to block 284 in which a check is made to determine whether or not the highest priority tunnel is within the set of tunnels that need activation. If yes, the process proceeds to block 286 where the highest priority tunnel is activated and the process then proceeds to block 278 and ends. Again, the activation of a tunnel causes the tunnel prioritization process to be started again. Alternatively, the process could loop from block 286 to block 280.

From block 284, if the highest priority tunnel is already activated the process then proceeds to block 290 in which a check is made to determine whether the second highest priority tunnel is activated (i.e. P2 is not in the set of tunnels that require activation). If not the process proceeds to block 292 in which the second highest priority tunnel is activated and the process proceeds to block 278 and ends.

Conversely, if from block 290 it is determined that the second highest priority tunnel is not in the set of tunnels requiring activation then the process proceeds to block 296 in which the most recently used tunnel in the tunnels requiring activation is activated and the process proceeds to block 278 and ends.

The use of FIGS. 1, 2A and 2B is illustrated with regard to two examples below. In both examples, the device includes a proprietary service/application that requires an activation of a tunnel for the device. The device is in a network that supports multiple tunnels. In the examples, it is preferred that multiple tunnels are active unless a high-speed connection needs to be made.

### EXAMPLE A

### WAP Browser Requiring Application Solo Mode

In order to ensure optimal performance for a user that is browsing the Internet over a carrier's wireless application protocol (WAP) browser, the WAP browser may be provided with a flag indicating that it prefers application solo mode.

At the outset, the mobile may be operating with a tunnel for the device services and with no other tunnel open. Thereafter, the user opens the WAP browser in the foreground, and the process starts in FIG. 1 by proceeding to block 112 determining that a foreground change has occurred. In this case, the process then proceeds to block 120 and determines that the WAP browser does in fact require application solo mode and therefore the process proceeds to block 122 in which the tunnel prioritization process is run indicating an application solo mode.

Referring to FIG. 2A the set of registered tunnels (REG) could include multiple tunnels and among them the device service tunnel as well as the WAP tunnel. The currently active tunnel for block 212 is the device service tunnel. Further, a watermark is provided, for example that the network service allows three tunnels to be opened.

In block 220 the required tunnel count is set to the minimum of size of the set of registered tunnels and the watermark. In this case, the required tunnel count could be set to three which is the watermark number, assuming the number of registered tunnels in the set of registered tunnels is equal to or greater than three.

The process then proceeds to block 230 in which a check is made to determine whether the mobile device is in application solo mode. In present example, the application on the mobile device is in application solo mode and the process then proceeds to block 232 in which the required tunnel count RTC is forced to one.

The process then proceeds to block 234 in which the highest priority tunnel is set is set to the WAP tunnel and to block 236 in which the second highest priority tunnel is set to the device tunnel.

The process then proceeds to block 252 in which the set of tunnels that should be active is initialized to an empty set and the process then proceeds to block 254 in which the number of tunnels in the set of tunnels that should be active is compared to the required tunnel count. In this case, since the SBA set was initialized, the count is zero, which is less than the RTC of one. In this regard, the process proceeds to block 256 in which a check is made to determine whether the highest priority tunnel is within the set of tunnels that should be active. Since it is not, the process proceeds to block 258 in which the highest priority tunnel is added to the set of tunnels that should be active and the process proceeds back to block 254.

At block 254 a check is again made to determine whether the number of tunnels within the set of tunnels that should be active is less then the required tunnel count. In this case, both are one and therefore the check at block 254 is false and the process proceeds to block 270 in which required deactivation indicates that the currently active device tunnel should be deactivated. Further, the process proceeds to block 272 in which the set of tunnels that require activation is incremented to include the highest priority tunnel.

The process then proceeds to block 274 in which it is determined that there are tunnels that need deactivation and the process proceeds to block 276 in which the recently used tunnel is deactivated. In this case, the process deactivates the device tunnel.

The process ends at block 278. However, the deactivation of a tunnel causes the process to start again at block 210. In this case the input includes set CA having no active tunnels. The process steps though as above, and in block 270 the set of tunnels requiring deactivation is now empty. The set of tunnels requiring activation in block 272 is set to the highest priority tunnel.

The process then proceeds to block 280 in which it determines whether or not a tunnel needs to be activated. Since the highest priority tunnel needs to be activated the process proceeds to block 284 in which the highest priority tunnel is found not to be activated. The process then proceeds to block 286 and the highest priority tunnel is activated. The process then ends at block 278. The activation causes the tunnel prioritization process to run again, but this time both RD in block 270 and RA in block 272 are empty, causing the process to end at block 282.

As seen from the above, only the high priority tunnel is activated and the remainder deactivated tunnels are closed on starting a WAP browser or bring the WAP browser to the foreground.

If the WAP browser is closed or put into the background, this will cause the tunnel prioritization process to run again.

### EXAMPLE B

### Starting a Non-Application Solo Mode Application

In a further example, the WAP browser that is started has been flagged to be a non-application solo mode application. Again, the preconditions in this case are that a devices services tunnel is already opened and no other tunnel is opened.

Referring to FIG. 1, the process starts at block 110 and determines that the WAP browser has been opened in block 112. The process then proceeds to block 120 to determine whether the application indicates application solo mode. In this case, the application does not indicate application solo mode, so the process proceeds to block 124 in which the tunnel prioritization process is run using standard mode.

Referring to FIG. 2A, the tunnel prioritization process starts at block 210 and proceeds to block 212 in which the one of the inputs is the set of registered tunnels. This could be a set of tunnels, which for example has three or four tunnels that are registered for the device. The set of currently active tunnels includes the device tunnel and the watermark again in this case is three.

The process then proceeds to block 220 in which the required tunnel count is set to the minimum of the number of registered tunnels with the set of registered tunnels and the watermark; in this case the required tunnel count is set to three.

The process then proceeds to block 230 in which a check is made to determine whether the focused tunnel is in application solo mode. Since it is not, the process proceeds to block 234 in which the focused tunnel is set to be the highest priority tunnel and the device tunnel is set to be the second highest priority tunnel in block 236.

The process then proceeds to block 252 in which the set of tunnels that should be active is initialized and the process proceeds to block 254 in which a determination is made to determine whether the set of tunnels that should be active is less then the required tunnel count. In this case, the required tunnel count is three and therefore the check at block 254 is true and the process proceeds to block 256. From block 256 the highest priority tunnel needs to be added to the set of tunnels that should be active and the process proceeds to block 258 in which the highest priority tunnel is added and the process then loops back to block 254.

In this case, the check at block 254 determines that there is one tunnel within the set of tunnels that should be active which is still less then the required tunnel count and the process proceeds to block 256. Here, the highest priority tunnel is already in the set of tunnels that should be active and the process then proceeds to block 260 in which a determination is made to determine whether the second highest priority tunnel is within the set of tunnels that should be active. Since it is not, the process proceeds to block 262 and adds the second priority tunnel to the set of tunnels that should be active and the process loops back to block 254.

A check is made to determine whether the number of tunnels within the set that should be active is less then the required tunnel count. In this case, there are two tunnels within the set that should be active which is still less then the required tunnel count and the process then proceeds to block 256, block 260 and block 262 in which the most recently used tunnel is added to the set of tunnels that should be active.

The process then proceeds back to block 254, where there are now three tunnels in the set that should be active, which is not less then the required tunnel count. The process then proceeds to block 270 in which the set of tunnels which require deactivation are found to have no tunnels. The process then proceeds to block 272 in which the set of tunnels that require activation are found to be the highest priority tunnel and the most recently used tunnel.

The process then proceeds to block 274 in which the determination is made that there are no tunnels that need deactivation. The process then proceeds to block 280 in which it is determined there are tunnels that need activation. The process then proceeds to block 284 in which the highest priority tunnel is determined to require activation. In this case, the process proceeds to block 286 in which the highest priority tunnel is activated and the process ends at block 278. The activation of a tunnel causes the tunnel prioritization process to run again, at which point the most recently used tunnel is next started.

The embodiment of FIGS. 1, 2A and 2B provide for the closing of tunnels in the case where an application has been flagged for application solo mode to ensure only one tunnel is active. This in turn ensures that a high speed radio access bearer is maintained for the application solo mode, thereby creating a better user experience.

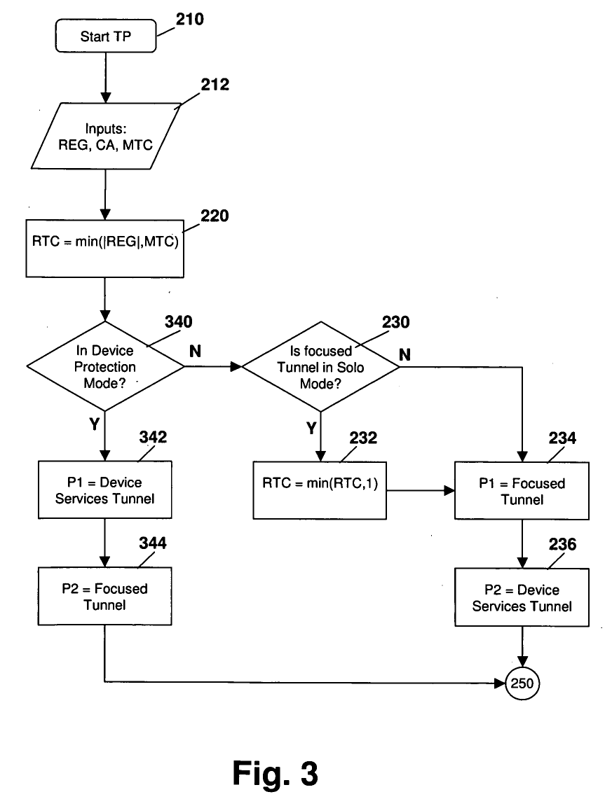

Reference is now made to FIG. 3. In certain instances, a “protection mode” is desirable to ensure the device tunnel is given priority. In the case of “protection mode”, the order priority from highest to lowest is the device tunnel, the focused tunnel, and an ordered list of most recently used tunnels. This contrasts with the device protection mode being disabled where the order priority would be, as described above, the focused tunnel, the device tunnel and an ordered list of most recently used tunnels.

In order to facilitate protection modes, the process diagram of FIG. 2A has been modified. Where applicable, like reference numerals have been used.

Referring to FIG. 3, the process for the tunnel prioritization process starts at block 210 and proceeds to block 212, providing inputs containing the set of registered tunnels, set of currently active tunnels and watermark. The process then proceeds to block 220 where the required tunnel count is set to be equal to the minimum of the number of registered tunnels within the set of registered tunnels and the watermark.

Instead of proceeding from block 220 to block 230 as in FIG. 2A, the process of FIG. 3 proceeds to block 340. In block 340 a check is made to determine whether the device is in protection mode. If not, the process proceeds to block 230 and continues as described above with reference to FIG. 2A.

Conversely, if it is determined in block 340 that the device is in protection mode, the process proceeds to block 342 in which the highest priority tunnel is set to be the device tunnel.

The process then proceeds to block 344 in which the second highest priority tunnel is set to be the focused tunnel.

From block 344, the process proceeds to connection point 250 in FIG. 2B and the process continues as described above with reference to FIG. 2B.

As will be appreciated, by setting the highest priority to the data services tunnel the data services tunnel is then established first.

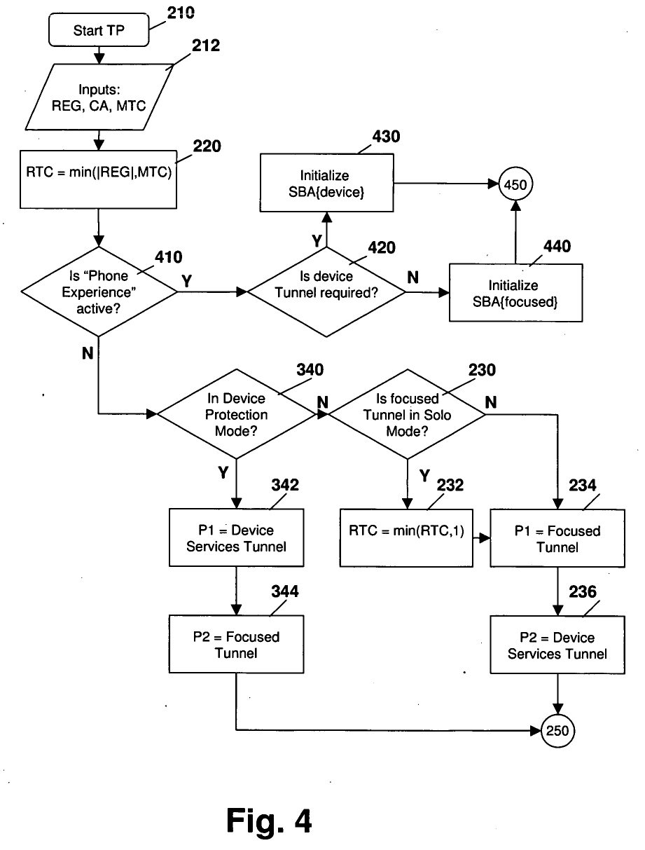

In a further alternative embodiment, preferences maybe designated for the tunnels that should be enabled during a circuit switched call. Reference is now made to FIG. 4.

FIG. 4 illustrates the example when the “phone experience” requires that certain tunnels be enabled during a circuit switched call. The process of FIG. 4 is similar to that of FIG. 3 and similar reference numerals have been used for like elements.

The process of FIG. 4 starts at the tunnel prioritization process of block 210 and proceeds to block 212, in which inputs REG, CA and MTC are provided. These correspond with the set of registered tunnels, the set of currently active tunnels and the current watermark.

In block 220 the required tunnel count is set to be the minimum of number of registered tunnels in the set of registered tunnels and the watermark.

From block 220 the process proceeds to block 410 instead of block 340, as in FIG. 3. In block 410 a check is made to determine whether the “phone experience” is active. As will be appreciated, this step determines whether specific tunnels should be enabled on a circuit switched call.

If the phone experience is not active, as found in block 410 the process proceeds to block 340 and proceeds in accordance with FIG. 3 above.

Conversely, if it is found in block 410 that the phone experience is active, the process proceeds to block 420 in which a check is made to determine whether a device tunnel is required for circuit switched calls. If yes, the process proceeds to block 430 in which the set of tunnels that should be active is initialized to have the device tunnel as part of the tunnels that should be active.

Conversely, if a device tunnel is not required then the process proceeds to block 440 in which the set of tunnels that should be active is initialized to include the focused tunnel as part of the set.

From block 430 or block 440 the process proceeds to entry point 450 of FIG. 2B and proceeds in accordance with the remaining blocks of FIG. 2B as described above.

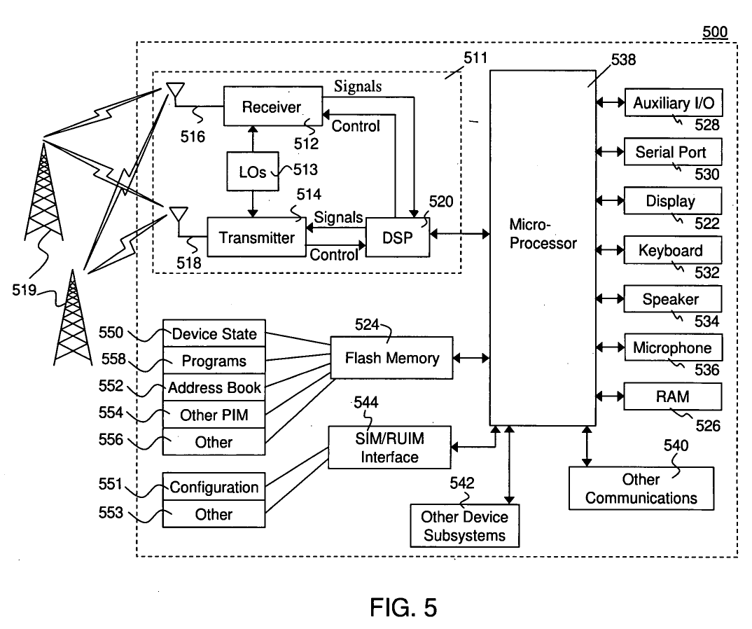

As will be appreciated, the checking of radio access bearers and establishing radio access bearers is done utilizing the processor on a mobile device, in combination with a communications subsystem of the mobile device. One such exemplary mobile device is illustrated below with reference to FIG. 5. The mobile device with reference to FIG. 5 is however not meant to be limiting and other mobile devices could also be used.

Mobile device 500 is preferably a two-way wireless communication device having at least voice and data communication capabilities. Mobile device 500 preferably has the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 500 is enabled for two-way communication, it will incorporate a communication subsystem 511, including both a receiver 512 and a transmitter 514, as well as associated components such as one or more, preferably embedded or internal, antenna elements 516 and 518, local oscillators (LOs) 513, and a processing module such as a digital signal processor (DSP) 520. As will be apparent to those skilled in the field of communications, the particular design of the communication subsystem 511 will be dependent upon the communication network in which the device is intended to operate.

Network access requirements will also vary depending upon the type of network 519. In some CDMA networks network access is associated with a subscriber or user of mobile device 500. A CDMA mobile device may require a removable user identity module (RUIM) or a subscriber identity module (SIM) card in order to operate on a CDMA network. The SIM/RUIM interface 544 is normally similar to a card-slot into which a SIM/RUIM card can be inserted and ejected like a diskette or PCMCIA card. The SIM/RUIM card can have memory and hold many key configuration 551, and other information 553 such as identification, and subscriber related information.

When required network registration or activation procedures have been completed, mobile device 500 may send and receive communication signals over the network 519. As illustrated in FIG. 5, network 519 can consist of multiple base stations communicating with the mobile device. For example, in a hybrid CDMA 1x EVDO system, a CDMA base station and an EVDO base station communicate with the mobile station and the mobile device is connected to both simultaneously. The EVDO and CDMA 1x base stations use different paging slots to communicate with the mobile device.

Signals received by antenna 516 through communication network 519 are input to receiver 512, which may perform such common receiver functions as signal amplification, frequency down conversion, filtering, channel selection and the like, and in the example system shown in FIG. 5, analog to digital (A/D) conversion. A/D conversion of a received signal allows more complex communication functions such as demodulation and decoding to be performed in the DSP 520. In a similar manner, signals to be transmitted are processed, including modulation and encoding for example, by DSP 520 and input to transmitter 514 for digital to analog conversion, frequency up conversion, filtering, amplification and transmission over the communication network 519 via antenna 518. DSP 520 not only processes communication signals, but also provides for receiver and transmitter control. For example, the gains applied to communication signals in receiver 512 and transmitter 514 may be adaptively controlled through automatic gain control algorithms implemented in DSP 520.

Mobile device 500 preferably includes a microprocessor 538 which controls the overall operation of the device. Communication functions, including at least data and voice communications, are performed through communication subsystem 511. Microprocessor 538 also interacts with further device subsystems such as the display 522, flash memory 524, random access memory (RAM) 526, auxiliary input/output (I/O) subsystems 528, serial port 530, one or more keyboards or keypads 532, speaker 534, microphone 536, other communication subsystem 540 such as a short-range communications subsystem and any other device subsystems generally designated as 542. Serial port 530 could include a USB port or other port known to those in the art.

Some of the subsystems shown in FIG. 5 perform communication-related functions, whereas other subsystems may provide “resident” or on-device functions. Notably, some subsystems, such as keyboard 532 and display 522, for example, may be used for both communication-related functions, such as entering a text message for transmission over a communication network, and device-resident functions such as a calculator or task list.

Operating system software used by the microprocessor 538 is preferably stored in a persistent store such as flash memory 524, which may instead be a read-only memory (ROM) or similar storage element (not shown). Those skilled in the art will appreciate that the operating system, specific device applications, or parts thereof, may be temporarily loaded into a volatile memory such as RAM 526. Received communication signals may also be stored in RAM 526.

As shown, flash memory 524 can be segregated into different areas for both computer programs 558 and program data storage 550, 552, 554 and 556. These different storage types indicate that each program can allocate a portion of flash memory 524 for their own data storage requirements. Microprocessor 538, in addition to its operating system functions, preferably enables execution of software applications on the mobile device. A predetermined set of applications that control basic operations, including at least data and voice communication applications for example, will normally be installed on mobile device 500 during manufacturing. Other applications could be installed subsequently or dynamically.

One software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 519. In a preferred embodiment, the PIM data items are seamlessly integrated, synchronized and updated, via the wireless network 519, with the mobile device user's corresponding data items stored or associated with a host computer system. Further applications may also be loaded onto the mobile device 500 through the network 519, an auxiliary I/O subsystem 528, serial port 530, short-range communications subsystem 540 or any other suitable subsystem 542, and installed by a user in the RAM 526 or preferably a non-volatile store (not shown) for execution by the microprocessor 538. Such flexibility in application installation increases the functionality of the device and may provide enhanced on-device functions, communication-related functions, or both. For example, secure communication applications may enable electronic commerce functions and other such financial transactions to be performed using the mobile device 500.

In a data communication mode, a received signal such as a text message or web page download will be processed by the communication subsystem 511 and input to the microprocessor 538, which preferably further processes the received signal for output to the display 522, or alternatively to an auxiliary I/O device 528.

A user of mobile device 500 may also compose data items such as email messages for example, using the keyboard 532, which is preferably a complete alphanumeric keyboard or telephone-type keypad, in conjunction with the display 522 and possibly an auxiliary I/O device 528. Such composed items may then be transmitted over a communication network through the communication subsystem 511.

For voice communications, overall operation of mobile device 500 is similar, except that received signals would preferably be output to a speaker 534 and signals for transmission would be generated by a microphone 536. Alternative voice or audio I/O subsystems, such as a voice message recording subsystem, may also be implemented on mobile device 500. Although voice or audio signal output is preferably accomplished primarily through the speaker 534, display 522 may also be used to provide an indication of the identity of a calling party, the duration of a voice call, or other voice call related information for example.

Serial port 530 in FIG. 5 would normally be implemented in a personal digital assistant (PDA)-type mobile device for which synchronization with a user's desktop computer (not shown) may be desirable, but is an optional device component. Such a port 530 would enable a user to set preferences through an external device or software application and would extend the capabilities of mobile device 500 by providing for information or software downloads to mobile device 500 other than through a wireless communication network. The alternate download path may for example be used to load an encryption key onto the device through a direct and thus reliable and trusted connection to thereby enable secure device communication. As will be appreciated by those skilled in the art, serial port 530 can further be used to connect the mobile device to a computer to act as a modem.

Other communications subsystems 540, such as a short-range communications subsystem, is a further optional component which may provide for communication between mobile device 500 and different systems or devices, which need not necessarily be similar devices. For example, the subsystem 540 may include an infrared device and associated circuits and components or a Bluetooth™ communication module to provide for communication with similarly enabled systems and devices.

While the above examples utilize HSDPA networks, the solution is equally applicable to other networks, which include but are not limited to Universal Mobile Telecommunications System (UMTS) networks, Global System for Mobile telephony (GSM) networks, Long Term Evolution (LTE) networks, among others. For example, in UMTS, the channels are cumulative and the data must therefore be shared between the channels.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method for establishing and maintaining a high speed tunnel between a mobile device and a network, the method comprising:
determining whether a foreground application on the mobile device requires the high speed tunnel, and
if the foreground application requires the high speed tunnel, closing all tunnels from the mobile device to a network except the tunnel for the foreground application.

2. The method of claim 1, wherein the tunnel is associated with a packet data protocol context.

3. The method of claim 2, wherein the packet data protocol context is associated with a radio access bearer.

4. The method of claim 3, wherein the high speed tunnel utilizes high speed downlink packet access.

5. The method of claim 1, wherein the closing all tunnels utilizes a tunnel prioritization process comprising:
forcing a required tunnel count to be set to one;
setting the highest priority tunnel to be a tunnel for the foreground application;
designating a set of tunnels that should be opened to be the highest priority tunnel; and
deactivating tunnels currently active not in the set of tunnels that should be opened.

6. The method of claim 1, further comprising:
restoring tunnels if the foreground application does not require the high speed tunnel.

7. The method of claim 6, wherein the restoring comprises:
assigning a required tunnel count to be a minimum of a watermark value and a number or registered tunnels;
designating a set of tunnels that should be opened to a prioritized list of tunnels having a size equal to the required tunnel count;
deactivating tunnels currently active and not in the set of tunnels that should be opened; and
activating tunnels not currently active but in the set of tunnels that should be opened.

8. The method of claim 1, further comprising, prior to the closing, checking whether the mobile device is in a protection mode, and if yes ensuring that a device tunnel remains active.

9. The method of claim 1, further comprising, prior to the closing, checking whether the mobile device is in a phone experience mode, and if yes initializing a set of tunnels that should be active to include a single tunnel.

10. The method of claim 9, wherein the single tunnel is a device tunnel if the device tunnel is required, or tunnel for the foreground application if a device tunnel is not required.

11. A mobile device configured to establish and maintain a high speed tunnel is open to a network, the mobile device comprising:
a communications subsystem; and
a processor, the processor configured to determine whether a foreground application on the mobile device requires the high speed tunnel, and if the foreground application requires the high speed tunnel, close all tunnels using the communications subsystem from the mobile device to a network except the tunnel for the high speed radio access bearer.

12. The mobile device of claim 11, wherein the tunnel is associated with a packet data protocol context.

13. The mobile device of claim 12, wherein the packet data protocol context is associated with a radio access bearer.

14. The mobile device of claim 13, wherein the high speed tunnel utilizes high speed downlink packet access.

15. The mobile device of claim 11, wherein the processor is configured to close all tunnels utilizing a tunnel prioritization process comprising:
forcing a required tunnel count to be set to one;
setting the highest priority tunnel to be a tunnel for the foreground application;
designating a set of tunnels that should be opened to be the highest priority tunnel; and
deactivating tunnels currently active not in the set of tunnels that should be opened.

16. The mobile device of claim 11, wherein the processor is further configured to restore tunnels if the foreground application does not require the high speed tunnel.

17. The mobile device of claim 16, wherein the restoring comprises:
assigning a required tunnel count to be a minimum of a watermark value and a number or registered tunnels;
designating a set of tunnels that should be opened to a prioritized list of tunnels having a size equal to the required tunnel count;
deactivating tunnels currently active and not in the set of tunnels that should be opened; and
activating tunnels not currently active but in the set of tunnels that should be opened.

18. The mobile device of claim 11, wherein the processor is further configured to, prior to the closing, check whether the mobile device is in a protection mode, and if yes ensure that a device tunnel remains active.

19. The mobile device of claim 11, wherein the processor is further configured to, prior to the closing, check whether the mobile device is in a phone experience mode, and if yes initialize a set of tunnels that should be active to include a single tunnel.

20. The mobile device of claim 19, wherein the single tunnel is a device tunnel if the device tunnel is required, or tunnel for the foreground application if a device tunnel is not required.
